(19) United States
(12) Patent Application Publication
(10) Pub. No.: US 2013/0136858 A1
(43) Pub. Date: May 30, 2013

(54) ADHESIVE RECYCLING DURING SPIN COATING

(71) Applicants: Gyanendra DUTT, Garden Grove, CA (US); Dung PHAN, Long Beach, CA (US); YounSang KIM, Irvine, CA (US); Elizabeth HOANG, Orange, CA (US)

(72) Inventors: Gyanendra DUTT, Garden Grove, CA (US); Dung PHAN, Long Beach, CA (US); YounSang KIM, Irvine, CA (US); Elizabeth HOANG, Orange, CA (US)

(73) Assignee: Henkel Corporation, Rocky Hill, CT (US)

(21) Appl. No.: 13/305,936

(22) Filed: Nov. 29, 2011

(51) Int. Cl. B05D 5/10; B05C 11/08; B05C 11/04; B05D 1/40

(52) U.S. Cl. 427/207.1; 118/52

(57) ABSTRACT

A spin coating apparatus for applying adhesive to a substrate includes: a rotatable chuck configured to receive and hold a substrate thereon; a nozzle positioned above the rotatable chuck and configured to dispense the adhesive onto a surface of the substrate; a containment pan surrounding the rotatable chuck and configured to contain excess adhesive; a collection container in fluid communication with the containment pan; and a removal device positioned within the containment pan configured to direct the excess adhesive into the collection container.

### BACKGROUND OF THE INVENTION

1. Field of the Invention

The present invention generally relates to a system and method for spin coating a liquid onto a substrate and, more particularly, to a system and method for recycling the adhesive that is spunoff the substrate during the spin coating procedure.

2. Description of Related Art

In a typical spin coating process, a desirable amount of a liquid material, such as an adhesive, is first applied to a top surface of a substrate from a liquid dispenser that is mounted above the substrate while the substrate is rotated on a vacuum chuck. The liquid material is thereby spread radially outward from the center of the substrate where it is applied by the liquid dispenser towards the edge of the substrate until the entire top surface of the substrate is covered with a thin layer. Excess liquid material is spun off the rotating substrate during the spin coating process into a containment pan. The rotational speed of the vacuum chuck and the amount of the liquid material applied at the center of the substrate can be determined and adjusted prior to and during an application process such that a predetermined, desirable thickness of the liquid material on the substrate is obtained. The rotational speed of the vacuum chuck is normally increased at the end of the application process to ensure that the entire surface of the substrate is evenly coated with the liquid material.

A typical spin coating apparatus 1 for coating a liquid on a substrate is shown in FIGS. 1 and 2. The apparatus 1 includes a drain cup 3 and a rotating platform 5, i.e. a vacuum chuck, positioned at the center of the drain cup 3 for supporting a substrate 7 on a top surface thereof. The rotating platform 5 can be rotated by a shaft 9 which is connected to an electric motor (not shown). The apparatus 1 further includes a dispensing nozzle 11 positioned above the rotating platform 5. The amount of the liquid supplied to the substrate 7 can be suitably controlled by adjusting the flow rate through the dispensing nozzle 11 from which the liquid is dispensed.

In the operation of the conventional spin coating apparatus 1, the rotating platform 5 is first loaded with a substrate 7 on a top surface thereof. The liquid dispenser 11 then approaches the center of the substrate 7 and applies a predetermined amount of a liquid material to the center of the substrate 7. The rotating platform 5 then spins to spread out the liquid material to evenly cover the top surface of the substrate 7. Extra liquid material 13 is thrown off the substrate surface into the drain cup 3 and discarded as waste.

The conventional spin-coating process discussed hereinabove utilizing the apparatus of FIGS. 1 and 2 results in a significant waste of the coating material. More specifically, when a liquid material is applied on a substrate utilizing the above described spin-coating process, 70% to 90% of the liquid material is spun off the substrate by the centrifugal force and is discarded as waste. This high level of waste has made spin coating economically unviable for several types of electronic packaging processes.

Accordingly, a need exists for a spin coating system and method that recycles the adhesive that is spun off during a spin coating procedure.

### SUMMARY OF THE INVENTION

An object of the present invention is to provide a spin coating system and method that recycles the liquid material or adhesive that is spun off during a spin coating procedure. More specifically, the current system and method discussed hereinabove can be modified to contain and capture the excess liquid material that is spun off the substrate. The captured material can then be pooled with fresh liquid material and applied to fresh wafers. By using the recycled liquid material for the spin coating process, the process waste and total cost can both be significantly lowered.

Therefore, provided is a spin coating apparatus for applying adhesive to a substrate that includes: a rotatable chuck configured to receive and hold a substrate thereon; a nozzle positioned above the rotatable chuck and configured to dispense the adhesive onto a surface of the substrate; a containment pan surrounding the rotatable chuck and configured to contain excess adhesive; a collection container in fluid communication with the containment pan; and a removal device positioned within the containment pan configured to direct the excess adhesive into the collection container.

The containment pan may be configured to have a substantially cylindrical shape. A bottom surface of the substantially cylindrical containment pan may include an opening in fluid communication with the collection container. The removal device may be configured as a squeegee that is driven along an interior wall of the substantially cylindrical containment pan to direct the excess adhesive into the opening.

In an alternative embodiment, the removal device may be a vacuum plate positioned to rotate around a bottom surface of the substantially cylindrical containment pan and remove the excess adhesive therefrom. The vacuum plate may be configured to remove excess adhesive from an interior wall of the substantially cylindrical containment pan. The excess adhesive removed from the bottom surface of the substantially cylindrical containment pan by the vacuum plate may be directed into the collection container by a vacuum line.

In yet another embodiment, the containment pan may have a substantially conical shape with sloping walls. The rotatable chuck may include a rotating shaft and a support plate positioned on a top surface of the rotating shaft. The rotating shaft may include a plurality of nozzles on an outer surface thereof in fluid communication with a fluid source. The collection container may be positioned at a tip of the substantially conical shaped containment pan. Fluid from the fluid source may be provided through the plurality of nozzles to force the excess adhesive off the sloping walls of the substantially conical shaped containment pan and into the collection container.

In each of the embodiments discussed hereinabove, a filter may be positioned upstream from the collection container to trap foreign particulates from the atmosphere and dust from the substrate that are in the excess adhesive before the excess adhesive is directed into the collection container.

In addition, provided is a method of applying an adhesive to a substrate using a spin coating apparatus. The method includes: positioning a substrate on a rotatable chuck; dispensing the adhesive onto a surface of the substrate using a nozzle positioned above the rotatable chuck; containing excess adhesive with a containment pan positioned to surround the rotatable chuck; and directing the excess adhesive into a collection container that is in fluid communication with the containment pan using a removal device positioned within the containment pan.

The containment pan may have a substantially cylindrical shape. A bottom surface of the substantially cylindrical containment pan may include an opening in fluid communication with the collection container. The removal device may be a squeegee that is driven along an interior wall of the substantially cylindrical containment pan to direct the excess adhesive into the opening. Alternatively, the removal device may be a vacuum plate positioned to rotate around a bottom surface of the substantially cylindrical containment pan and remove the excess adhesive therefrom. The excess adhesive removed from the bottom surface of the substantially cylindrical containment pan by the vacuum plate may be directed into the collection container by a vacuum line.

The containment pan may also be of a substantially conical shape with sloping walls and the collection container may be positioned at a tip thereof. The rotatable chuck may include a rotating shaft that has a plurality of nozzles on an outer surface thereof in fluid communication with a fluid source and a support plate positioned on a top surface of the rotating shaft. Fluid from the fluid source may be provided through the plurality of nozzles to force the excess adhesive off the sloping walls of the substantially conical shaped containment pan and into the collection container.

Also provided is a method of recycling adhesive during a spin coating procedure. The method includes collecting excess adhesive produced on the containment pan during the spin coating procedure; mixing the collected excess adhesive with adhesive that has not been used during a spin coating procedure to create recycled adhesive; and spin coating a substrate using the recycled adhesive.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIGS. 1 and 2 are perspective, schematic views of a conventional spin coating apparatus utilized in spin coating a liquid material onto a substrate;

FIG. 3 is a perspective, schematic view of a first embodiment of a spin coating apparatus in accordance with the present invention;

FIG. 4 is a top plan view of the spin coating apparatus of FIG. 3;

FIG. 5 is a perspective, schematic view of a second embodiment of a spin coating apparatus in accordance with the present invention;

FIG. 6 is a perspective, schematic view of a third embodiment of a spin coating apparatus in accordance with the present invention; and

FIG. 7 is a top plan view of the spin coating apparatus of FIG. 6.

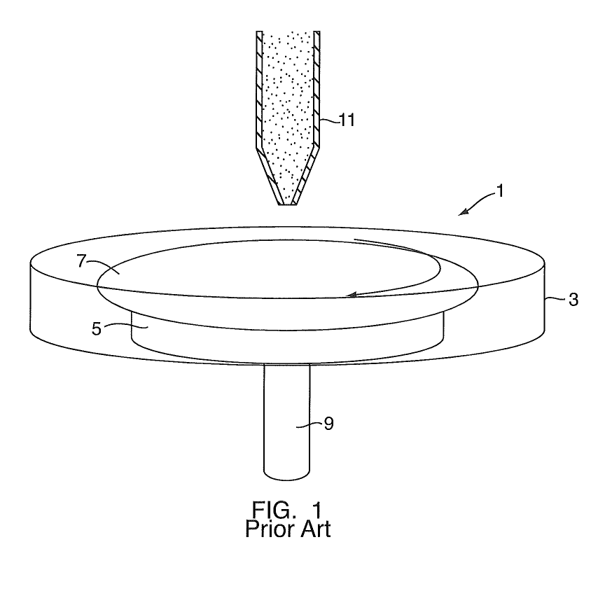

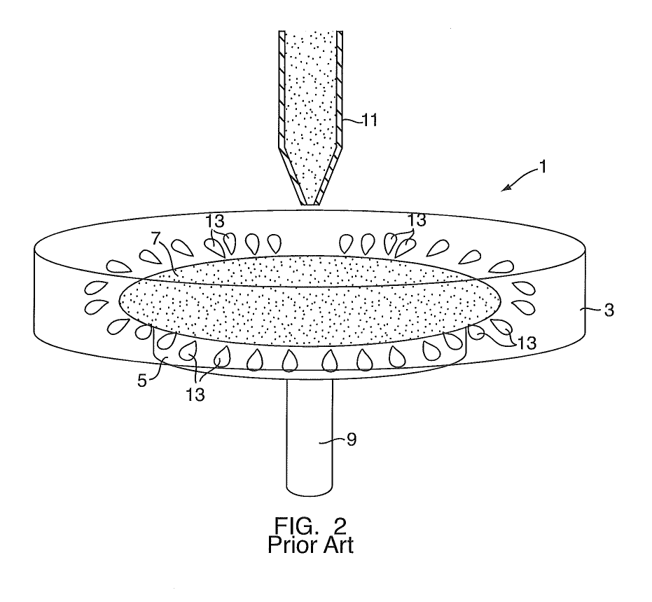

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

Various embodiments of a spin coating system that recycles the liquid material or adhesive that is spun off during a spin coating procedure are discussed hereinafter. Each of these embodiments contains and captures the excess liquid material that is spun off the substrate. The captured material is then pooled with fresh liquid material and applied to fresh wafers. By using the recycled liquid material for the spin coating process, the process waste and total cost can both be significantly lowered.

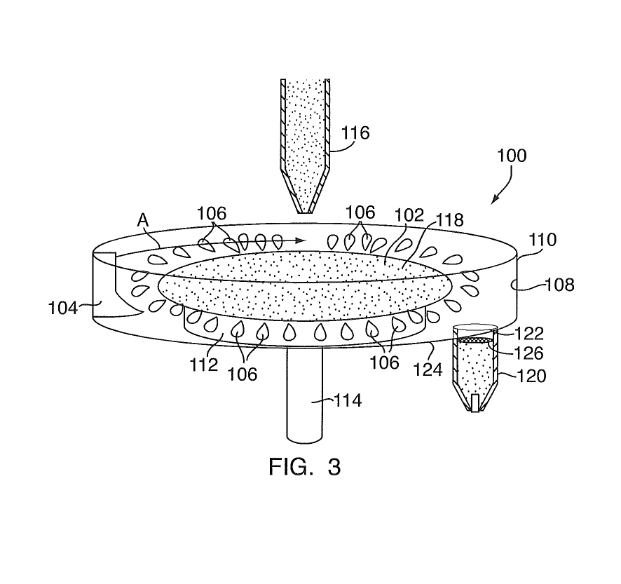

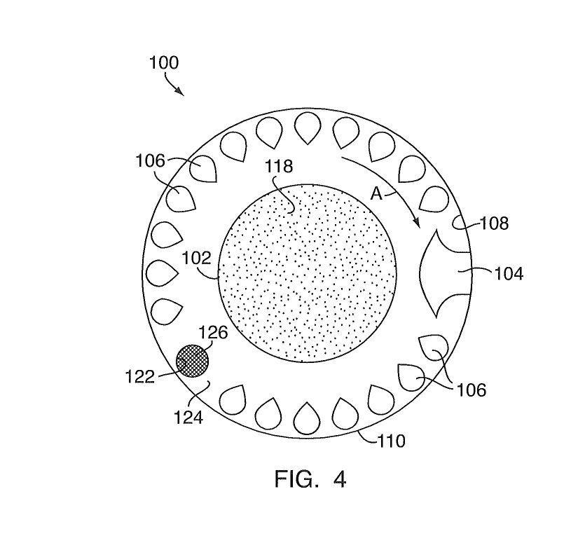

With reference to FIGS. 3 and 4, a first embodiment of a spin coating apparatus 100 for applying adhesive to a substrate 102 that utilizes a squeegee 104 to scrub excess adhesive 106 from interior walls 108 of a containment pan 110 for collection and reuse is illustrated. The apparatus includes a chuck 112 that is supported for rotation by a shaft 114. The shaft 114 is rotated by an electric motor (not shown) or any other suitable motive device. The chuck 112 is configured to receive and hold the substrate 102 thereon. A nozzle 116 is positioned above the chuck 112 and configured to dispense the adhesive onto a top surface 118 of the substrate 102. The containment pan 110 is positioned to surround the chuck 112 and configured to contain the excess adhesive 106 that is spun off during a spin coating procedure. The containment pan 110 is configured to have a substantially cylindrical shape. A collection container 120 is provided in fluid communication with the containment pan 110 via a drain 122 provided on a bottom surface 124 of the containment pan 110.

In operation of the spin coating apparatus 100, the chuck 112 is first loaded with a substrate 102 on a top surface thereof. The nozzle 116 then approaches the center of the substrate 102 and applies a predetermined amount of adhesive to the center of the substrate 102. The chuck 112 then spins to spread out the adhesive to evenly cover the top surface of the substrate 102. Excess adhesive 106 is thrown off the substrate surface into the containment pan 110 and collects on the interior walls 108 of the containment pan.

In order to collect and recycle the excess adhesive 106, the squeegee 104 is driven along the interior walls 108 of the substantially cylindrical containment pan 110 in the direction of arrow A to direct the excess adhesive 106 into the drain 122 and thereafter the collection container 120 upon the completion of the spin coating process described above. The captured excess adhesive is then pooled with fresh liquid material and applied to fresh substrates.

The squeegee 104 may be driven by an electric motor (not shown) or any other suitable motive device. The squeegee 104 may have any suitable shape, such as a curved L-shape to help in wiping the excess adhesive 106 from the interior walls 108 of the containment pan 110.

A filter 126 may be positioned in the area of the drain 122 and upstream from the collection container 120 to trap foreign particulates from the atmosphere and dust from the substrate 102 that are in the excess adhesive 106 before the excess adhesive 106 is directed into the collection container 120. The filter 126 may be in the range of 2-10 microns, and desirably 3-5 microns. The filter 126 is provided to prevent contamination of the excess adhesive 106 during the recycling/re-use process.

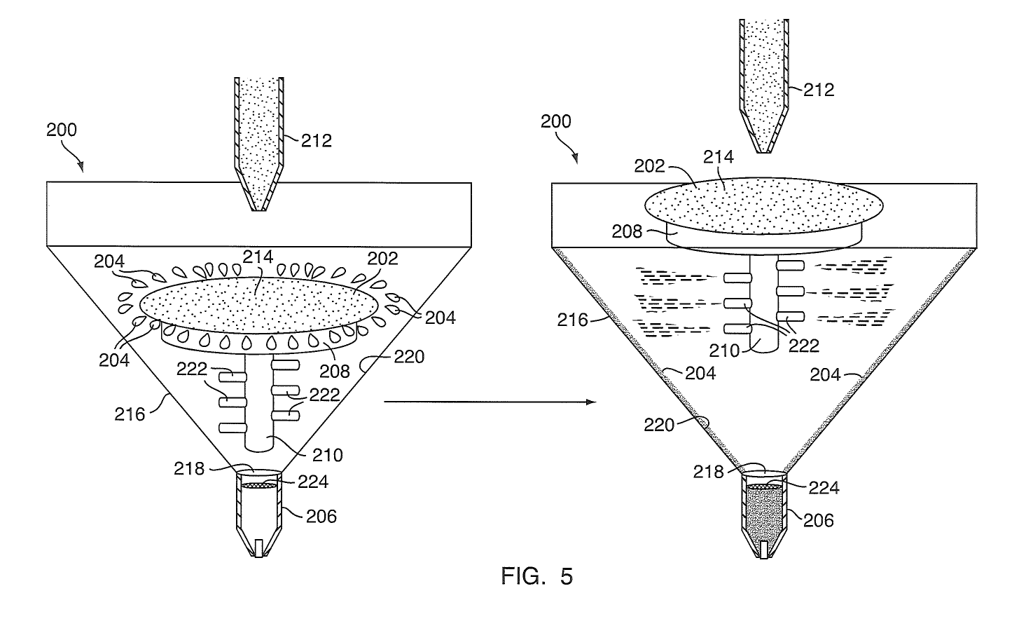

With reference to FIG. 5, a second embodiment of a spin coating apparatus 200 for applying adhesive to a substrate 202 that utilizes a forced fluid and gravity to force excess adhesive 204 into a collection container 206 is illustrated. The apparatus includes a chuck 208 that is supported for rotation by a shaft 210. The shaft 210 is rotated by an electric motor (not shown) or any other suitable motive device. The chuck 208 is configured to receive and hold the substrate 202 thereon. A nozzle 212 is positioned above the chuck 208 and configured to dispense the adhesive onto a top surface 214 of the substrate 202. A containment pan 216 is positioned to surround the chuck 208 and configured to contain the excess adhesive 204 that is spun off during a spin coating procedure. The containment pan 216 is configured to have a substantially conical shape with sloping walls and a drain 218 at a tip thereof. The collection container 206 is positioned in fluid communication with the drain 218.

In operation of the spin coating apparatus 200, the chuck 208 is first loaded with a substrate 202 on a top surface thereof. The nozzle 212 then approaches the center of the substrate 202 and applies a predetermined amount of adhesive to the center of the substrate 202. The chuck 208 then spins to spread out the adhesive to evenly cover the top surface 214 of the substrate 202. Excess adhesive 204 is thrown off the substrate surface into the containment pan 216 and collects on the interior sloping walls 220 thereof.

In order to collect and recycle the excess adhesive 204, the shaft 210 includes a plurality of nozzles 222 on an outer surface thereof in fluid communication with a fluid source (not shown). After the completion of the spin coating process described above, the substrate is raised above the containment pan 216 by an elevating mechanism (not shown) and fluid from the fluid source may be provided through the plurality of nozzles 222 to force the excess adhesive off the interior sloping walls 220 of the containment pan 216 and into the collection container 206. The fluid may be any suitable fluid, such as air, another gas, or a liquid. The captured excess adhesive is then pooled with fresh liquid material and applied to fresh substrates.

A filter 224 may be positioned in the area of the drain 218 and upstream from the collection container 216 to trap foreign particulates from the atmosphere and dust from the substrate 202 that are in the excess adhesive 204 before the excess adhesive 204 is directed into the collection container 216. The filter 224 may be in the range of 2-10 microns, and desirably 3-5 microns. The filter 224 is provided to prevent contamination of the excess adhesive 204 during the recycling/re-use process.

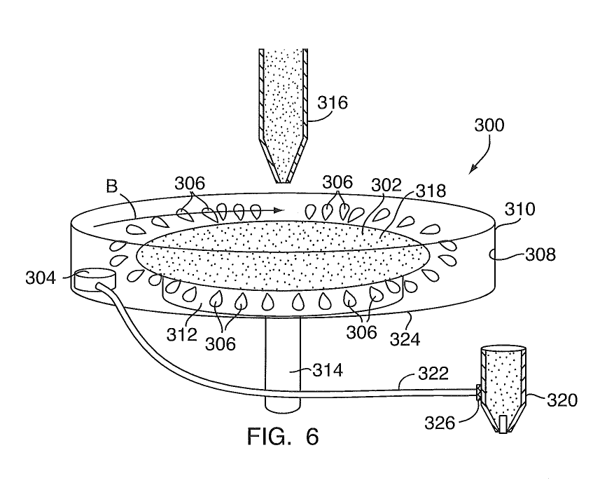

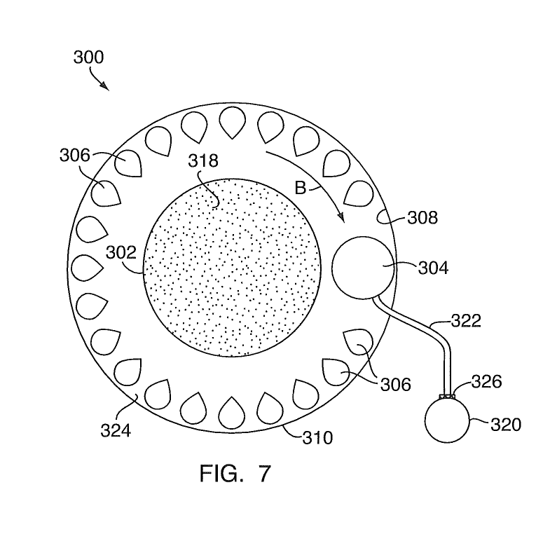

With reference to FIGS. 6 and 7, a third embodiment of a spin coating apparatus 300 for applying adhesive to a substrate 302 that utilizes a rotating vacuum plate 304 to remove excess adhesive 306 from interior walls 308 and bottom surface 324 of a containment pan 310 for collection and re-use is illustrated. The apparatus includes a chuck 312 that is supported for rotation by a shaft 314. The shaft 314 is rotated by an electric motor (not shown) or any other suitable motive device. The chuck 312 is configured to receive and hold the substrate 302 thereon. A nozzle 316 is positioned above the chuck 312 and configured to dispense the adhesive onto a top surface 318 of the substrate 302. The containment pan 310 is positioned to surround the chuck 312 and configured to contain the excess adhesive 306 that is spun off during a spin coating procedure. The containment pan 310 is configured to have a substantially cylindrical shape. A collection container 320 is provided in fluid communication with the containment pan 310 via a vacuum line 322 provided between the rotating vacuum plate 304 and the collection container 320.

In operation of the spin coating apparatus 300, the chuck 312 is first loaded with a substrate 302 on a top surface thereof. The nozzle 316 then approaches the center of the substrate 302 and applies a predetermined amount of adhesive to the center of the substrate 302. The chuck 312 then spins to spread out the adhesive to evenly cover the top surface of the substrate 302. Excess adhesive 306 is thrown off the substrate surface into the containment pan 310 and collects on the interior walls 308 and bottom surface 324 of the containment pan 310.

In order to collect and recycle the excess adhesive 306, the rotating vacuum plate 304 is driven along the interior walls 308 and bottom surface 324 of the substantially cylindrical containment pan 310 in the direction of arrow B to suction the excess adhesive 306 into the vacuum line 322 and thereafter the collection container 320 upon the completion of the spin coating process described above. The captured excess adhesive 306 is then pooled with fresh liquid material and applied to fresh substrates. The rotating vacuum plate 304 may be driven by an electric motor (not shown) or any other suitable motive device.

A filter 326 may be positioned at any point along the vacuum line 322 and upstream from the collection container 320 to trap foreign particulates from the atmosphere and dust from the substrate 302 that are in the excess adhesive 306 before the excess adhesive 306 is directed into the collection container 320. The filter 326 may be in the range of 2-10 microns, and desirably 3-5 microns. The filter 326 is provided to prevent contamination of the excess adhesive 306 during the recycling/re-use process.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

The invention claimed is:

1. A spin coating apparatus for applying adhesive to a substrate comprising:
a rotatable chuck configured to receive and hold a substrate thereon;
a nozzle positioned above the rotatable chuck and configured to dispense the adhesive onto a surface of the substrate;
a containment pan surrounding the rotatable chuck and configured to contain excess adhesive;
a collection container in fluid communication with the containment pan; and
a removal device positioned within the containment pan configured to direct the excess adhesive into the collection container.

2. The spin coating apparatus of claim 1, wherein the containment pan has a substantially cylindrical shape.

3. The spin coating apparatus of claim 2, wherein a bottom surface of the substantially cylindrical containment pan includes an opening in fluid communication with the collection container.

4. The spin coating apparatus of claim 3, wherein the removal device is a squeegee that is driven along an interior wall of the substantially cylindrical containment pan to direct the excess adhesive into the opening.

5. The spin coating apparatus of claim 2, wherein the removal device is a vacuum plate positioned to rotate around a bottom surface of the substantially cylindrical containment pan and remove the excess adhesive therefrom.

6. The spin coating apparatus of claim 5, wherein the vacuum plate removes excess adhesive from an interior wall of the substantially cylindrical containment pan.

7. The spin coating apparatus of claim 5, wherein the excess adhesive removed from the bottom surface of the substantially cylindrical containment pan by the vacuum plate is directed into the collection container by a vacuum line.

8. The spin coating apparatus of claim 1, wherein the containment pan has a substantially conical shape with sloping walls.

9. The spin coating apparatus of claim 8, wherein the rotatable chuck comprises a rotating shaft and a support plate positioned on a top surface of the rotating shaft.

10. The spin coating apparatus of claim 9, wherein the rotating shaft comprises a plurality of nozzles on an outer surface thereof in fluid communication with a fluid source.

11. The spin coating apparatus of claim 10, wherein the collection container is positioned at a tip of the substantially conical shaped containment pan.

12. The spin coating apparatus of claim 11, wherein fluid from the fluid source is provided through the plurality of nozzles to force the excess adhesive off the sloping walls of the substantially conical shaped containment pan and into the collection container.

13. The spin coating apparatus of claim 1, further comprising a filter positioned upstream from the collection container to trap foreign particulates from the atmosphere and dust from the substrate that are in the excess adhesive before the excess adhesive is directed into the collection container.

14. A method of applying an adhesive to a substrate using a spin coating apparatus, the method comprising:
positioning a substrate on a rotatable chuck;
dispensing the adhesive onto a surface of the substrate using a nozzle positioned above the rotatable chuck;
containing excess adhesive with a containment pan positioned to surround the rotatable chuck; and
directing the excess adhesive into a collection container that is in fluid communication with the containment pan using a removal device positioned within the containment pan.

15. The method of claim 14, wherein the containment pan has a substantially cylindrical shape.

16. The method of claim 15, wherein a bottom surface of the substantially cylindrical containment pan includes an opening in fluid communication with the collection container.

17. The method of claim 16, wherein the removal device is a squeegee that is driven along an interior wall of the substantially cylindrical containment pan to direct the excess adhesive into the opening.

18. The method of claim 15, wherein the removal device is a vacuum plate positioned to rotate around a bottom surface of the substantially cylindrical containment pan and remove the excess adhesive therefrom.

19. The method of claim 18, wherein the excess adhesive removed from the bottom surface of the substantially cylindrical containment pan by the vacuum plate is directed into the collection container by a vacuum line.

20. The method of claim 14, wherein the containment pan has a substantially conical shape with sloping walls and the collection container is positioned at a tip thereof, the rotatable chuck comprises a rotating shaft having a plurality of nozzles on an outer surface thereof in fluid communication with a fluid source and a support plate positioned on a top surface of the rotating shaft, and fluid from the fluid source is provided through the plurality of nozzles to force the excess adhesive off of the sloping walls of the substantially conical shaped containment pan and into the collection container.

21. A method of recycling adhesive during a spin coating procedure comprising:
collecting excess adhesive produced on a containment pan during the spin coating procedure;
mixing the collected excess adhesive with adhesive that has not been used during the spin coating procedure to create recycled adhesive; and
spin coating a substrate using the recycled adhesive.
